(19) United States
(12) Patent Application Publication
(10) Pub. No.: US 2008/0298779 A1
(43) Pub. Date: Dec. 4, 2008

(54) MOVING IMAGE COMMUNICATION DEVICE, SEMICONDUCTOR INTEGRATED CIRCUIT AND MOVING IMAGE COMMUNICATION METHOD USED FOR COMMUNICATION OF MOVING IMAGE

(76) Inventors: Yoshiaki Mimata, Osaka (JP); Masahiro Ogawa, Osaka (JP); Minako Shimizu, Kyoto (JP); Kenji Nakamura, Osaka (JP)

Correspondence Address: MCDERMOTT WILL & EMERY LLP, 600 13TH STREET, NW, WASHINGTON, DC, 20005-3096, US

(21) Appl. No.: 12/132,953

(22) Filed: Jun. 4, 2008

(30) Foreign Application Priority Data
Jun. 4, 2007 (JP) 2007-147886

(51) Int. Cl. H04N 7/64

(52) U.S. Cl. 386/116; 386/E05.035

(57) ABSTRACT

A transmitter transmits moving image data generated by an image generator to a communication line. A controller judges whether or not the moving image data can be transmitted based on communication status in the communication line. An image analyzer analyzes the moving image data and calculates an information volume thereof when it is judged by the controller that the transmission of the moving image data is not possible, and a storage memory stores the moving image data therein. A transmit image selector selects the moving image data to be read for transmission from all of the moving image data stored in the storage memory based on the information volume when a result of the judgment by the controller shows that non-transmittable status is changed to transmittable status and transmits the selected moving image data to the transmitter.

### BACKGROUND OF THE INVENTION

1. Field of the Invention

The present invention relates to a moving image communication device for transmitting moving image data to a communication line via cable communication or radio communication, and a semiconductor integrated circuit and a moving image communication method used for communication of a moving image.

2. Description of the Related Art

In the communication of moving image data according to a conventional technology, a minimum communication band is set in order to transmit the moving image data while maintaining an image quality of the data. In the case where a sufficient communication band is not secured when the moving image data is transmitted in the conventional communication of the moving image data thus constituted, the band is controlled to have a range broader than that of a set reference band.

There is another conventional technology, wherein the moving image data, when it is transmitted, is converted into a transmission packet and transmitted in real time and any transmission-failed packet is retransmitted after the real-time transmission. An example of the technology is recited in the Unexamined Japanese Patent Publication No. 2003-18525.

The conventional technologies, however, are disadvantageous in that, when such an abnormal states as congestion occurs when the moving image data is transmitted in real time via a communication line such as network, it is not possible to transmit the moving image data for the duration of the abnormal status, and a client thereby cannot obtain the moving image data.

In the case where the moving image data has been subjected to the inter-frame prediction encoding such as the MPEG (Moving Picture Experts Group), the moving image data cannot be updated before such a key frame as I (intra) picture is transmitted even after the recovery of the communication status in the communication line.

### SUMMARY OF THE INVENTION

Therefore, a main object of the present invention is to improve operations at the time when any communication difficulties arise.

A moving image communication device according to the present invention comprises;

an image generator for generating moving image data;

a transmitter for transmitting the moving image data to a communication line;

a controller for judging whether or not the moving image data can be transmitted based on communication status in the communication line;

an image analyzer for analyzing the moving image data and calculating an information volume thereof when it is judged by the controller that the transmission of the moving image data is not possible;

a storage memory for storing the moving image data therein when it is judged by the controller that the transmission of the moving image data is not possible; and

a transmit image selector for selecting the moving image data to be read for transmission from all of the moving image data stored in the storage memory based on the information volume when the judgment result by the controller shows that non-transmittable status is changed to transmittable status and transmitting the selected moving image data to the transmitter.

The moving image communication device according to the present invention may be configured such that the transmit image selector preferentially selects the moving image data whose information volume is large.

The moving image communication device according to the present invention may further comprise a selector for switching between a first route in which the moving image data is directly transmitted from the image generator to the transmitter and a second route in which the moving image data is transmitted from the image generator to the transmitter via the image analyzer, the storage memory and the transmit image selector, wherein

the controller sends an instruction to set the first route when the judgment by the controller shows the transmittable status and an instruction to set the second route when the judgment by the controller shows the non-transmittable status to the selector.

A moving image communication method according to the present invention corresponding to the moving image communication device according to the present invention comprises steps of:

generating moving image data;

judging whether or not the moving image data can be transmitted based on communication status of the communication line;

analyzing the moving image data and calculating an information volume thereof when it is judged in the judging step that the moving image data cannot be transmitted;

storing the moving image data when it is judged in the judging step that the moving image data cannot be transmitted;

selecting the moving image data to be read for transmission from all of the moving image data stored in the storing step based on the information volume when the judgment result in the judging step shows that non-transmittable status is changed to transmittable status and reading the selected moving image data; and

transmitting the moving image data generated in the generating step to the communication line when the judgment result in the judging step shows the transmittable status, and transmitting the moving image data read in the selecting step to the communication line when the judgment result in the judging step shows that the non-transmittable status is changed to the transmittable status.

In the foregoing constitution, the controller judges whether or not the communication is possible based on the communication status of the communication line. When the judgment result shows the transmittable status, the controller transmits the moving image data generated by the image generator to the transmitter. The transmitter transmits the received moving image data to the communication line. When the judgment result shows the non-transmittable status, the controller sends the moving image data generated by the image generator to the image analyzer and the storage memory. The image analyzer analyzes the received moving image data and calculates the information volume thereof, while the storage memory stores therein the moving image data. During the described operation, the real-time transmission is interrupted; however, the moving image data is saved. When the controller detects the communication status in the line showing the non-transmittable status is changed to the transmittable status, the moving image data stored in the storage memory is read for transmission. When the moving image data is read, the transmission image selector selects the moving image data to be read for transmission from all of the stored moving image data based on the information volume previously calculated by the image analyzer during a data non-transmission period. For example, moving image data whose information volume is large is preferentially read. The transmitter transmits the moving image data selected by the transmission image selector to the communication line. According to the present invention, even in the case where any trouble occurs in the communication line and the transmission of the moving image data can not be thereby accomplished, the moving image data can be stored and the stored moving image data can be transmitted to a client via the communication line after the recovery of the communication line. Accordingly, the client can confirm later the moving images during the halt of the communication. Further, the client can speedily return to the real-time images again because the moving image data whose information volume is large is preferentially read.

The moving image communication device according to the present invention may be configured such that the transmission image selector can change a selection threshold value when the moving image data to be read for transmission is selected. Accordingly, the volume of the moving image data to be transmitted can be changed. More specifically, the selection threshold value is set to be relatively high when the client wants to return to real-time images earlier, while the selection threshold value is set to be relatively low when the clients wants to confirm images in more detail rather than returning to the real-time images earlier.

The moving image communication device according to the present invention may further comprises an re-encoder for decoding the moving image data read from the storage memory and re-encoding the decoded data.

The moving image communication method according to the present invention corresponding to the moving image communication device thus constituted may be configured such that the moving image data selected and read is decoded and re-encoded, and then transmitted to the communication line in the transmitting step.

When the moving image data read from the storage memory is thus re-encoded, not only a key frame such as I picture but also all of frames, even in the case of the moving image data subjected to inter-frame prediction encoding, such as the MPEG, can be transmitted. In the case where a bit rate is changed based on the information volume in the analysis result by the image analyzer when the moving image data is re-encoded, data can be changed to a more suitable size.

The moving image communication device according to the present invention may be configured such that the image generator is configured to generate the moving image data by means of inter-frame prediction encoding,

the image analyzer is omitted, and

the transmission image selector selects the moving image data to be read for transmission based on differential information generated by the image generator when the inter-frame prediction encoding is implemented.

The moving image communication method according to the present invention corresponding to the moving image communication device thus constituted may be configured such that:

the calculating step is omitted,

the moving image data is generated by means of inter-frame prediction encoding in the generating step, and

the moving image data to be read for transmission is selected in the selecting step from all of the moving image data stored in storing step based on differential information in the inter-frame prediction encoding process.

When the image generator for generating the moving image data by means of the inter-frame prediction encoding is thus provided, an effect similar to that of the above described can be exerted without the image analyzer.

The moving image communication device according to the present invention may be configured such that the transmitter transmits an analysis result by the image analyzer when a judgment result by the controller shows that non-transmittable status is changed to transmittable status. Accordingly, amore efficient selection threshold value of the transmit image selector can be accurately determined by the client.

According to the present invention, when it is not possible to transmit moving image data due to any trouble in the communication line, the moving image data is stored, and the stored moving image data is transmitted to the client via the communication line when the communication line recovers from the trouble. Therefore, in the present invention, the moving images during the halt of the communication can be confirmed by the client later, and the client can speedily return to the real-time images again since the moving image data whose information volume is large is preferentially read.

The present invention, wherein the images during the halt of the communication can be confirmed and the client can speedily return to the real-time images, has a lot of potential for being used in the field of communication cameras, monitor cameras and the like.

### BRIEF DESCRIPTION OF THE DRAWINGS

These and other objects as well as advantages of the invention will become clear by the following description of preferred embodiments of the invention and be specified in the claims attached hereto. A number of benefits not recited in this specification will come to the attention of the skilled in the art upon the implementation of the present invention.

FIG. 1 is a block diagram illustrating a constitution of a moving image communication device according to a preferred embodiment 1 of the present invention.

FIG. 2 is a flow chart illustrating operations of the moving image communication device according to the preferred embodiment 1.

FIG. 3 is a conceptual view of moving image data transmission based on a storage memory and a table showing moving image analyzing results according to the preferred embodiment 1.

FIGS. 4A-4C are graphs each showing a relationship between passage time and a volume of stored data in the storage memory according to the preferred embodiment 1.

FIG. 5 is a block diagram illustrating a constitution of a moving image communication device according to a preferred embodiment 2 of the present invention.

FIG. 6 is a flow chart illustrating operations of the moving image communication device according to the preferred embodiment 2.

FIG. 7 is a block diagram illustrating a constitution of a moving image communication device according to a preferred embodiment 3 of the present invention.

### DETAILED DESCRIPTION OF THE INVENTION

Hereinafter, preferred embodiments of a moving image communication device according to the present invention are described in detail referring to the drawings.

### Preferred Embodiment 1

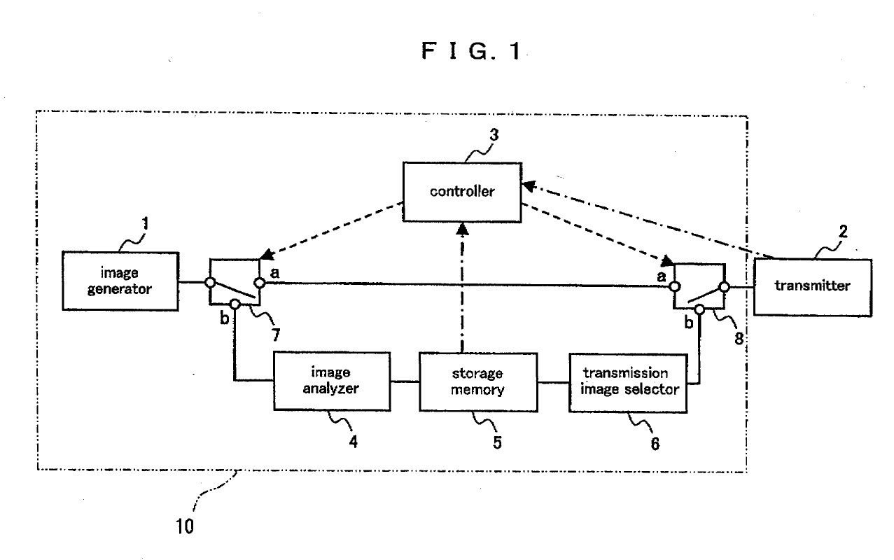

FIG. 1 is a block diagram illustrating a constitution of a moving image communication device according to a preferred embodiment 1 of the present invention. Referring to reference numerals shown in FIG. 1, 1 denotes an image generator, 2 denotes a transmitter, 3 denotes a controller, 4 denotes an image analyzer, 5 denotes a storage memory, 6 denotes a transmission image selector, 7 denotes an input-side selector, and 8 denotes an output-side selector. All of the components, except for the transmitter 2, (image generator 1, controller 3, image analyzer 4, storage memory 5, transmission image selector 6, input-side selector 7 and output-side selector 8) are provided in a semiconductor integrated circuit 10.

The image generator 1 generates moving image data. The transmitter 2 transmits the moving image data generated by the image generator 1 to a communication line such as a network. The controller 3 judges whether or not the communication is possible based on communication status in the communication line in the transmitter 2. The image analyzer 4 analyzes the moving image data generated by the image generator 1 to thereby calculate an information volume thereof when a result of the judgment by the controller 3 shows non-transmittable status. The storage memory 5 stores therein the moving image data generated by the image generator 1 when the judgment result by the controller 3 shows non-transmittable status. The transmission image selector 6 selects the moving image data to be read for transmission from the storage memory 5 based on the information volume calculated by the image analyzer A when the judgment result by the controller 3 shows that the communication status changes from non-transmittable to transmittable. The input-side selector 7 determines if the moving image data from the image generator 1 should be directly outputted to the transmitter 2 or outputted to a route of the image analyzer 4 and then switches between the two accordingly. The output-side selector 8 determines which of the input-side selector 7 and the transmit image selector 6 should be connected to the transmitter 2 and then switches between the two accordingly. The controller 3 judges whether the data communication via the communication line is possible based on the communication status in the communication line in the transmitter 2, and controls the input-side selector 7 and the output-side selector 8 using a result of the judgment.

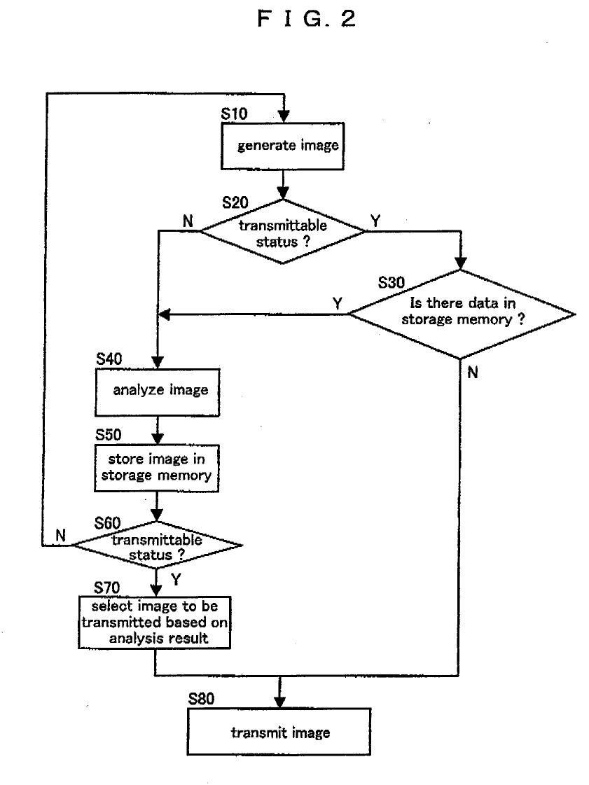

The operations of the moving image communication device according to the present preferred embodiment thus constituted is described referring to a flow chart shown in FIG. 2. In Step S10, the image generator 1 generates the moving image data. In Step S20, the controller 3 judges from the state of the transmitter 2 whether or not the current communication line status is capable of communication, and the operation advances to Step S30 when it is judged that the communication is possible, while the operation advancing to Step S40 after switching the input-side selector 7 to “b” side when it is judged that the communication is not possible.

In the Step S30 implemented when communication is possible, the controller 3 judges whether or not there is any moving image data stored in the storage memory 5. Upon the judgment that there is no data, the controller 3 switches the input-side selector 7 to “a” side and the output-side selector 8 to “a” side, and then the operation advances to Step S80. In the Step S80, the transmitter 2 transmits the moving image data directly inputted from the image generator 1 to the communication line. When the judgment in the Step S30 shows the storage memory 5 contains the data therein, the controller 3 switches the input-side selector 7 to “b” side and then advances to Step S40. The switchover of the selectors 7 and 8 to “a” side means the selection of a switch terminal “a” for selecting a first route in which the image generator 1 and the transmitter 2 are directly connected to each other not by way of the image analyzer 4, storage memory 5 and transmit image selector 6. The switchover of the selectors 7 and 8 to “b” side means the selection of a switch terminal b for selecting a second route in which the image generator 1 and the transmitter 2 are connected to each other by way of the image analyzer 4, storage memory 5 and transmit image selector 6.

In the Step S40 implemented when the communication is not possible or there is no moving image data in the storage memory 5 though the communication is possible, the image analyzer 4 analyzes the moving image data generated by the image generator 1 and stores the information volume of the moving image data thereby obtained as a result of the analysis.

In Step S50, the moving image data generated by the image generator 1 is stored in the storage memory 5. In Step S60, the controller 3 judges again whether or not the data communication is available. The operation advances to Step S70 when it is judged that the data can be transmitted, while returning to the Step S10 in order to generate the next moving image data when it is judged otherwise.

In the case where the data can be transmitted from the beginning or the communication recovers from its failure, the operation advances to Step 370, and then the controller 3 switches the output-side selector 8 to “b” side and reads only moving image data whose information volume is large from the storage memory 5 based on the analysis result by the transmit image selector 6 in the Step S40. Then, the moving image data is transmitted from the transmitter 2 in Step S80.

Below is given the summary of the operations. In the case where the communication is possible and any moving image data is not found in the storage memory 5, the controller 3 switches the input-side selector 7 and the output-side selector 8 to “a” side and directly transmits moving image data from the image generator 1 to the transmitter 2. As a result, the moving image data is transmitted in real time from the transmitter 2 to the communication line.

In the case where the storage memory 5 contains therein moving image data in the state where the communication is possible, the controller 3 switches the input-side selector 7 to “b” side and stores moving image data obtained then in the storage memory 5, and then, switches the output-side selector 8 to “b” side. The controller then selectively reads moving image data whose information volume is large from the storage memory 5 and transmits the read moving image data from the transmitter 2.

When the communication is not possible, the controller 3 switches the input-side selector 7 to “b” side and stores moving image data obtained then in the storage memory 5, and waits for the recovery of the communication line so that the data car be transmitted. When it is judged that the communication line returns to a state where the communication is possible, the controller 3 selectively reads the moving image data whose information volume is large from the storage memory 5 and transmits the read moving image data from the transmitter 2.

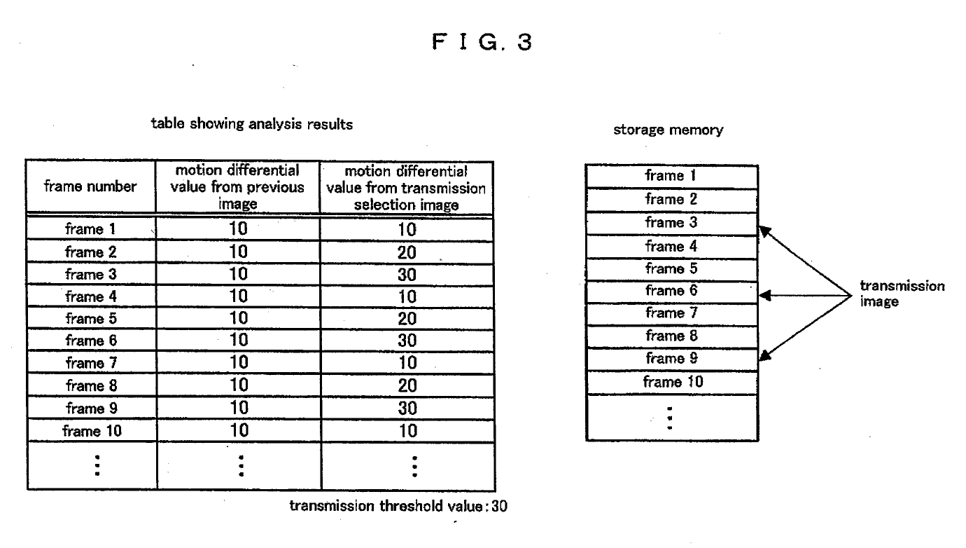

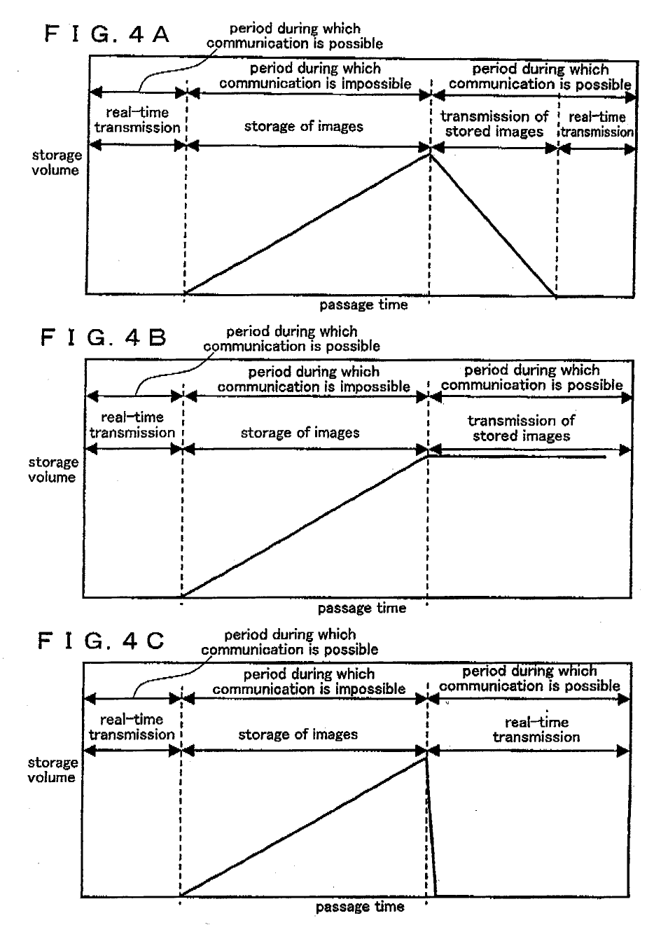

FIG. 3 is a conceptual view illustrating the selection of the moving image data to be transmitted based on the storage memory 5 and a table showing moving image analysis results. FIG. 4 is a graph showing a relationship between passage time in the transmission and a volume of the data stored in the storage memory 5. It is assumed in this description that, in order to simplify the description, the image analyzer 4 performs such a motion analysis that is used in the MPEG, and handles moving image data in which inter-frame motion differentials are all equal.

In the case where it is set in the controller 3 that moving image data whose data differential value from the previous moving image data selected to be transmitted is at least 30 units in the moving image analysis result is selected by the transmission image selector 6, the moving image data read from the storage memory 5 and transmitted are frame 3, frame 6, frame 9, . . . , in that order. Because a speed at which the moving image data is read (reading speed) from the storage memory 5 is three times as fast as a speed at which the moving image data is stored in the storage memory 5, the client can more speedily return to real-time images as shown in FIG. 4A. At the time, moving image data whose differential value is 20 units or 10 units is not read from the storage memory 5 and discarded. The operations are based on control which gives a priority to an early return to real-time images rather than high-quality moving images. Notwithstanding the foregoing, if time permits, moving image data whose differential value is 20 units may be read from the storage memory 5.

The transit image selector 6 can change its selection threshold value. When the selection threshold value is set to be relatively low, the client can confirm more of moving image data during the halt of the communication. When the client wants to confirm all of the moving images during the communication halt, the client has only to set the selection threshold value at zero, and the relationship between the passage time and the storage volume of the storage memory 5 then is as shown in FIG. 4B. In the control shown in FIG. 4B, it becomes difficult to return to real-time images though the image quality of the moving images is guaranteed.

When the selection threshold value of the transmit image selector 6 is set to be relatively high, the client can speedily return to the real-time images. In the case where the moving images during the communication halt are unnecessary, the client can immediately return to the real-time images by setting the threshold value at a largest level. The relationship between the passage time and the storage volume of the storage memory 5 then is as shown in FIG. 4C.

In the case where the client wants to control the time necessary for the return to the real-time images, the client may set a threshold value in the main device when the communication restarts. In that case, the table showing the analysis result obtained by the analysis by the image analyzer 4 is transmitted to the client beforehand when the data communication restarts. As a result, the client can more accurately judge the selection threshold value which is more efficient.

According to the present preferred embodiment, even when abnormal status occurs in the communication line and it thereby becomes impossible to transmit moving image data, the client can more efficiently confirm the moving images during the communication halt when the communication restarts, and can thereby speedily return to the real-time images.

### Preferred Embodiment 2

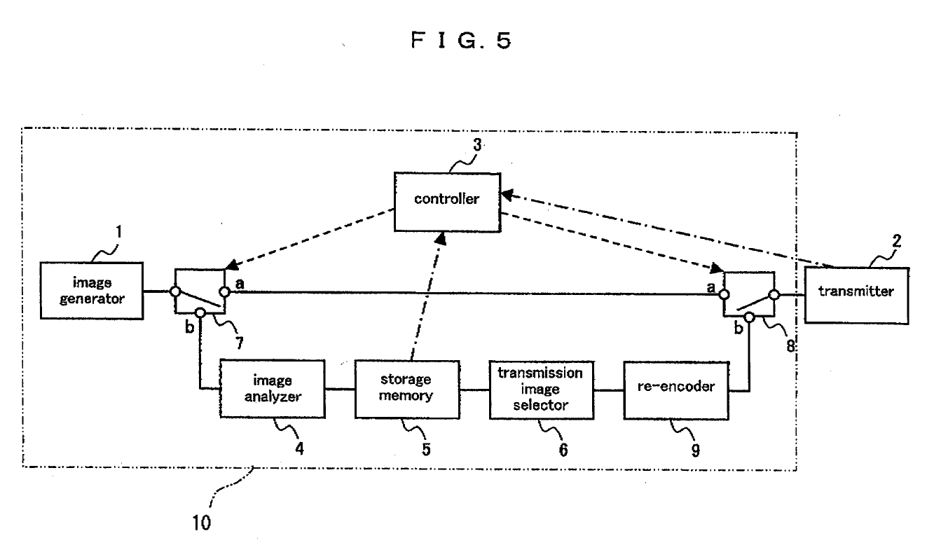

FIG. 5 is a block diagram illustrating a constitution of a moving image communication device according to a preferred embodiment 2 of the present invention. In FIG. 5, the same reference symbols as those shown in FIG. 1 according to the preferred embodiment 1 denote the same components. The present preferred embodiment is characterized in that a re-encoder 9 is provided subsequent to the transmit image selector 6, the re-encoder 9 re-encoding the moving image data to be transmitted when moving image data is selected from the storage memory 5.

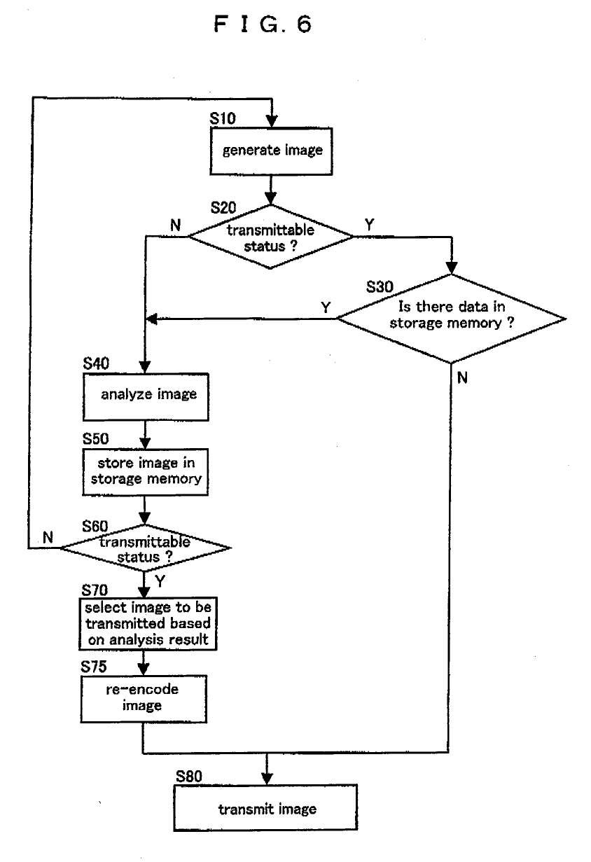

Operations of the moving image communication device according to the present preferred embodiment thus constituted are described referring to a flow chart shown in FIG. 6. The flow chart is different to that of FIG. 2 according to the preferred embodiment 1 in that Step S75 for a re-encoding process is further added. After moving image data to be read from the storage memory 5 is selected in Step S70, the moving image data read from the storage memory 5 is decoded and thereby extended, and then, re-encoded again in the re-encoder in the Step S75. In Step S80, the re-encoded moving image data is transmitted from the transmitter 2 to the communication line.

In the preferred embodiment 1, only a key frame such as I picture in the MPEG and a frame predicted from frames to be selectively transmitted can be transmitted in the case of moving image data subjected to the inter-frame prediction encoding such as the MPEG.

In the present preferred embodiment, however, the re-encoder 6 is provided so as to decode and re-encode the moving image data read from the storage memory 5. Therefore, the moving image data in all of the frames can be transmitted even in the case where the moving image data subjected to the inter-frame prediction encoding is handled in the image generator 1. When a bit rate is changed based on the analysis result by the image analyzer 4 in the re-encoding process, data can be changed to a more suitable size.

### Preferred Embodiment 3

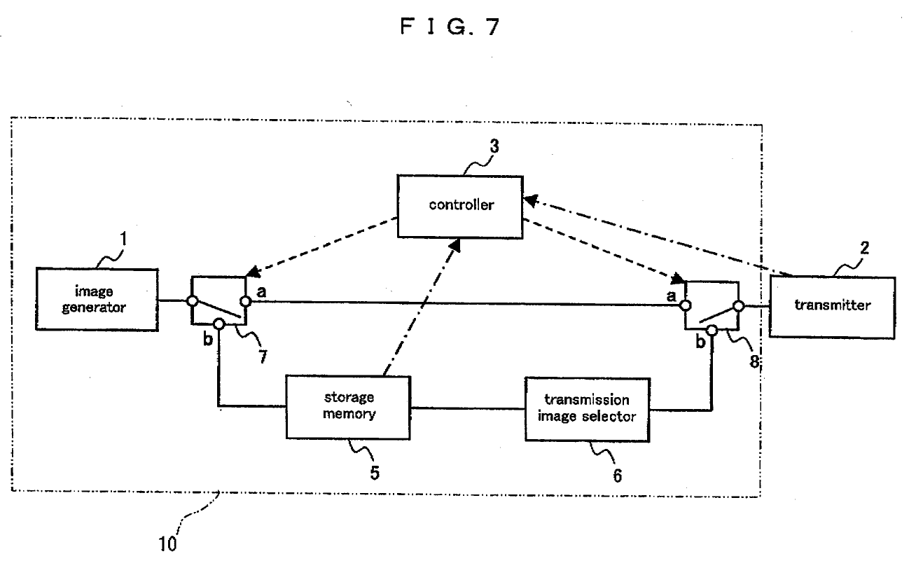

FIG. 7 is a block diagram illustrating a constitution of a moving image communication device according to a preferred embodiment 3 of the present invention. In FIG. 7, the same reference symbols as those shown in FIG. 1 according to the preferred embodiment 1 denote the same components. The present preferred embodiment is characterized in that the image analyzer 4 according to the preferred embodiment 1 (FIG. 1) is omitted. The image generator 1 uses a motion prediction result generated when the moving image data is generated as an analysis material in the moving image analysis based on the MPEG. Accordingly, an effect similar to that of the preferred embodiment 1 can be exerted without the image analyzer.

In FIG. 7, the re-encoder 9 may be additionally provided in the same manner as shown in FIG. 5. All of the preferred embodiments described so far described the methods applied when abnormal status occurs in the communication line during the communication period; however, the respective methods may be applied before the communication starts. Accordingly, the client can confirm the images generated before the communication starts.

The preferred embodiments described so far are merely examples, and the preferred embodiments can be variously modified within the scope of the invention.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A moving image communication device comprising:
an image generator for generating moving image data;
a transmitter for transmitting the moving image data to a communication line;
a controller for judging whether or not the moving image data can be transmitted based on communication status in the communication line;
an image analyzer for analyzing the moving image data and calculating an information volume thereof when it is judged by the controller that the transmission of the moving image data is not possible;
a storage memory for storing the moving image data therein when it is judged by the controller that the transmission of the moving image data is not possible; and
a transmit image selector for selecting the moving image data to be read for transmission from all of the moving image data stored in the storage memory based on the information volume when a result of the judgment by the controller shows that non-transmittable status is changed to transmittable status and transmitting the selected moving image data to the transmitter.

2. The moving image communication device as claimed in claim 1, wherein the transmit image selector preferentially selects the moving image data whose information volume is large.

3. The moving image communication device as claimed in claim 1, further comprising a selector for switching between a first route in which the moving image data is directly transmitted from the image generator to the transmitter and a second route in which the moving image data is transmitted from the image generator to the transmitter via the image analyzer, the storage memory and the transmit image selector, wherein
the controller sends an instruction to set the first route when the judgment by the controller shows transmittable status and an instruction to set the second route when the judgment by the controller shows non-transmittable status to the selector.

4. The moving image communication device as claimed in claim 1, wherein the transmission image selector can change a selection threshold value when the moving image data to be read for transmission is selected.

5. The moving image communication device as claimed in claim 1, further comprising a re-encoder for decoding the moving image data read from the storage memory and re-encoding the decoded data.

6. The moving image communication device as claimed in claim 1, wherein
the image generator is configured to generate the moving image data by means of inter-frame prediction encoding,
the image analyzer is omitted, and
the transmission image selector selects the moving image data to be read for transmission based on differential information generated by the image generator when the inter-frame prediction encoding is implemented.

7. The moving image communication device as claimed in claim 1, wherein
the transmitter transmits a result of the analysis by the image analyzer when a result of the judgment by the controller shows that non-transmittable status is changed to transmittable status.

8. A semiconductor integrated circuit comprising:
the image generator, the image analyzer, the transmission image selector and the controller provided in the moving image communication device claimed in claim 1.

9. A semiconductor integrated circuit comprising:
the image generator, the image analyzer, the transmission image selector, the controller and the re-encoder provided in the moving image communication device claimed in claim 5.

10. A semiconductor integrated circuit comprising:
the image generator, the transmission image selector, the controller and the re-encoder provided in the moving image communication device claimed in claim 6.

11. A moving image communication method comprising steps of
generating moving image data;
judging whether or not the moving image data can be transmitted based on communication status of the communication line;
analyzing the moving image data and calculating an information volume thereof when it is judged in the judging step that the moving image data cannot be transmitted;
storing the moving image data when it is judged in the judging step that the moving image data cannot be transmitted;
selecting the moving image data to be read for transmission from all of the moving image data stored in the storing step based on the information volume when the judgment result in the judging step shows that non-transmittable status is changed to transmittable status and reading the selected moving image data; and
transmitting the moving image data generated in the generating step to the communication line when the judgment result in the judging step shows the transmittable status, and transmitting the moving image data read in the selecting step to the communication line when the judgment result in the judging step shows that the non-transmittable status is changed to the transmittable status.

12. The moving image communication method as claimed in claim 11, wherein
the calculating step is omitted,
the moving image data is generated by means of inter-frame prediction encoding in the generating step, and
the moving image data to be read for transmission is selected in the selecting step from all of the moving image data stored in storing step based on differential information in the inter-frame prediction encoding process.

13. The moving image communication method as claimed in claim 11, wherein
the moving image data selected and read is decoded and re-encoded, and then transmitted to the communication line in the transmitting step.
